(19) United States
(12) Patent Application Publication
(10) Pub. No.: US 2024/0000253 A1
(43) Pub. Date: Jan. 4, 2024

(54) TABLEWARE AND METHOD OF MANUFACTURING THE SAME

(71) Applicant: NATIONAL CHENG KUNG UNIVERSITY, Tainan City (TW)

(72) Inventors: Yu Chi CHANG, Tainan City (TW); Ming-Yueh CHUANG, Tainan City (TW); Hao-Jung LIU, Miaoli County (TW); Ya-Lan HSU, Chiayi County (TW)

(21) Appl. No.: 18/341,778

(22) Filed: Jun. 27, 2023

(30) Foreign Application Priority Data
Jun. 27, 2022 (TW) 111123821

(51) Int. Cl. A47G 21/06; A47G 21/18; A47G 21/04; A47G 21/02; A47G 19/02

(52) U.S. Cl. CPC A47G 21/103; A47G 21/18; A47G 21/04; A47G 21/023; A47G 19/02

(57) ABSTRACT

The present invention relates to tableware and a method of manufacturing the tableware. The method can be performed under a specific weight ratio of konjac powder to an alkaline agent, a specific temperature of a molding process, and a water proofing treatment using oil, resulting in the tableware having good strength, excellent water resistance and thermal stability.

### RELATED APPLICATION

This application claims priority to Taiwan Application Serial Number 111123821, filed on Jun. 27, 2022 which is herein incorporated by reference in its entirety.

### BACKGROUND

### Field of Invention

The present invention relates to tableware and a method of manufacturing the tableware, and more particularly relates to the tableware with water resistance and thermal stability and the method of manufacturing the tableware.

### Description of Related Art

Conventional plastic tableware (such as polypropylene tableware) is non-biodegradable and thus causes environmental pollution. Therefore, biodegradable tableware has been developed, including paper tableware, starch-based tableware, and hydrogel-based tableware.

Paper tableware is made from plant fibers. Although paper tableware has excellent biodegradability, it has poor water resistance. In addition, starch-based tableware can be made from plant parts (such as corn and beans) containing starch, and hydrogel-based tableware can be made from hydrogel material (such as agar and gelatin). Although both starch-based tableware and hydrogel-based tableware are safe to use and biodegradable, the water resistance and thermal stability are still poor.

In view of these, it is necessary to develop new tableware and a new method of manufacturing the tableware to solve the aforementioned drawbacks.

### SUMMARY

In view of the above problems, an aspect of the present invention is to provide a method of manufacturing a tableware. In the method of manufacturing the tableware, the tableware having good strength, excellent water resistance, and excellent thermal stability are manufactured by using a specific weight ratio of konjac powder to an alkaline agent, a specific temperature of a modulating process, and a water-proofing process using an oil.

Another aspect of the present invention is to provide a tableware. The tableware is manufactured by the method of manufacturing the tableware described above.

According to an aspect of the present invention, a method of manufacturing a tableware is provided. In the method of manufacturing the tableware, a preparing process is performed on konjac powder, an alkaline agent and a water to form a block mass, wherein a weight ratio of the konjac powder to the alkaline agent is 18 to 22. Next, a modulating process is performed on the block mass to obtain a tableware-shaped dough, wherein the modulating process is performed at a temperature of less than 70° C. Then, a deacetylation process is performed on the tableware-shaped dough to obtain a non-setting tableware, wherein a water body is used to contact the tableware-shaped dough during the deacetylation process, and a temperature of the water body is not less than 65° C. Next, a drying process and a water-proofing process are sequentially performed on the non-setting tableware to obtain the tableware, wherein the water-proofing process is performed by using an oil to contact the non-setting tableware after the drying process, a temperature of the oil is 100° C. to 180° C., and the oil comprises unsaturated fatty acids.

According to one embodiment of the present invention, an amount of the konjac powder is 3 weight percents to 10 weight percents, based on a total weight of the konjac powder, the alkaline agent, and the water as 100 weight percents.

According to another embodiment of the present invention, the alkaline agent is selected from a group consisting of potassium hydroxide, sodium hydroxide, magnesium oxide, calcium oxide, magnesium hydroxide, and calcium hydroxide.

According to yet another embodiment of the present invention, a thickness of a sidewall of the tableware-shaped dough is 0.1 mm to 5 mm.

According to yet another embodiment of the present invention, a temperature of the drying process is more than 70° C. but not more than 100° C.

According to yet another embodiment of the present invention, a polyunsaturation of the unsaturated fatty acids is 55% to 65%.

According to yet another embodiment of the present invention, a processing time of the water-proofing process is 1 minute to 5 minutes.

According to one embodiment of present invention, the water-proofing process excludes performing a hydrophobic treatment on a surface of the tableware.

According to one embodiment of present invention, carboxymethylcellulose, methylcellulose, glycerin, vegetable chitosan, soybean pulp, rice straw and/or glucose is further used in the preparing process.

According to one embodiment of present invention, the tableware is selected from a group consisting of chopsticks, a fork, a spoon, a bowl, a plate, a cup, and a straw.

According to another aspect of the present invention, a tableware is provided. The tableware is manufactured by the method described above, wherein a glass transition temperature of the tableware is 244.5° C. to 260° C.

According to one embodiment of the present invention, a chemical structure of the tableware comprises hydrophobic groups formed from the unsaturated fatty acids.

According to another aspect of the present invention, a method of manufacturing a tableware is provided. In the method of manufacturing the tableware, a preparing process is performed on konjac powder, an alkaline agent and a water to form a block mass, wherein a weight ratio of the konjac powder to the alkaline agent is 18 to 22. Next, a modulating process is performed on the block mass to obtain tableware-shaped dough, wherein the modulating process is performed at a temperature of less than 70° C. Then, a deacetylation process is performed on the tableware-shaped dough to obtain an non-setting tableware, wherein a water body is used to contact the tableware-shaped dough during the deacetylation process, and a temperature of the water body is 65° C. to 100° C. Next, a drying process and a water-proofing process are sequentially performed on the non-setting tableware to obtain the tableware, wherein the water-proofing process is performed by using an oil to contact the non-setting tableware after the drying process, a temperature of the oil is 100° C. to 180° C., the oil includes unsaturated fatty acids, and a polyunsaturation of the unsaturated fatty acids is 55% to 65%.

According to one embodiment of the present invention, an amount of the konjac powder is 3 weight percents to 10 weight percents, based on a total weight of the konjac powder, the alkaline agent, and the water as 100 weight percents.

According to one embodiment of the present invention, the alkaline agent is selected from a group consisting of potassium hydroxide, sodium hydroxide, magnesium oxide, calcium oxide, magnesium hydroxide, and calcium hydroxide.

According to another embodiment of the present invention, a thickness of a sidewall of the tableware-shaped dough is 0.1 mm to 5 mm.

According to another embodiment of the present invention, a temperature of the drying process is more than 70° C. but not more than 100° C.

According to another embodiment of the present invention, a monounsaturation of the unsaturated fatty acids is 18% to 24%.

According to another embodiment of the present invention, the water-proofing process excludes performing a hydrophobic treatment on a surface of the tableware.

According to another embodiment of the present invention, the tableware is selected from a group consisting of chopsticks, a fork, a spoon, a bowl, a plate, a cup, and a straw.

In an application of the tableware and the method of manufacturing the tableware, in which the tableware having good strength, excellent water resistance, and excellent thermal stability is manufactured by using the specific weight ratio of the konjac powder to the alkaline agent, the specific temperature of the modulating process, and the water-proofing process using oil.

### BRIEF DESCRIPTION OF THE DRAWINGS

Please refer to the description below and accompany with corresponding drawings to more fully understand embodiments of the present invention and advantages thereof. It has to be emphasized that all kinds of features are not drawn in scale and only for illustration. The description regarding to the drawings as follows:

FIG. 1 illustrates a flow chart of a method of manufacturing a tableware according to an embodiment of the present invention.

### DETAILED DESCRIPTION

Manufacturing and usage of embodiments of the present invention are discussed in detail below. However, it can be understood that various applicable invention concepts provided by embodiments can be implemented in various specific contents. The specific embodiments discussed are only for illustration, but not be limiting scope of the present invention.

In a method of manufacturing a tableware of the present invention, the tableware is manufactured by using konjac powder and an alkaline agent with a weight ratio of 18 to 22, a temperature in a modulating process of less than 70° C., and a water-proofing process using an oil. In the tableware, unsaturated carbon bonds in the chemical structure of unsaturated fatty acids contained in the oil react with hydroxyl groups in a chemical structure of molecules of the konjac powder forming the tableware, so as to ether groups are produced, which generates a cross-linked structure. Therefore, a glass transition temperature of the resulted tableware is increased, thereby enhancing strength, water resistance, and thermal stability of the tableware. In addition, the tableware of the present invention can include, but not limited to, chopsticks, a fork, a spoon, a bowl, a plate, a cup, a straw, and any combinations thereof.

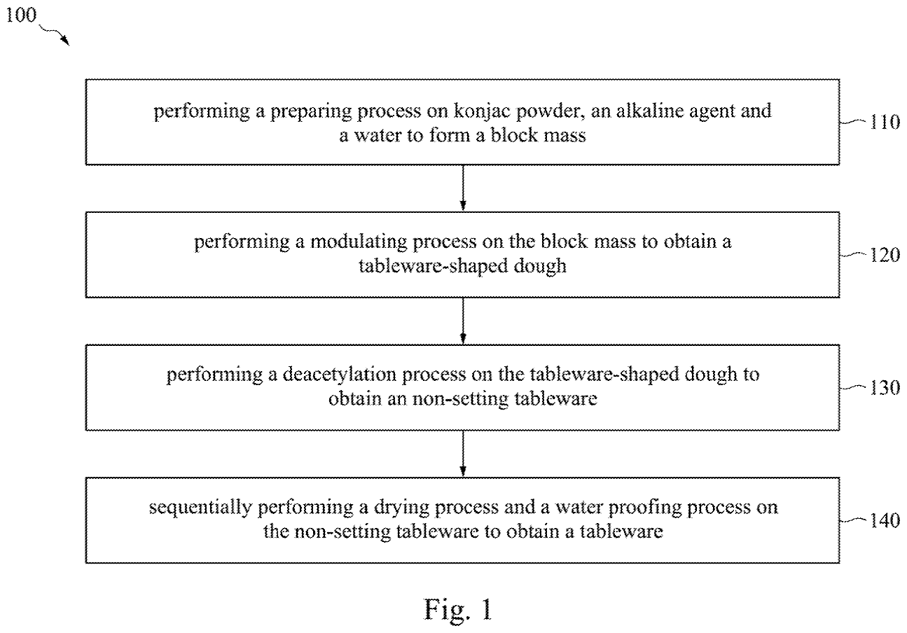

With reference to FIG. 1, in a method 100, a preparing process is firstly performed on konjac powder, an alkaline agent, and a water to form a block mass, as illustrated in an operation 110. The alkaline agent is used to provide cations, such that the konjac powder are subjected to a deacetylation. In some embodiments, the alkaline agent is selected from a group consisting of potassium hydroxide, sodium hydroxide, magnesium oxide, calcium oxide, magnesium hydroxide, and calcium hydroxide.

In some embodiments, based on a total weight of the konjac powder, the alkaline agent, and the water as 100 weight percents, an amount of the konjac powder is 3 weight percents to 10 weight percents, and preferably is 5 weight percents to 8 weight percents. When the amount of the konjac powder is in the aforementioned ranges, a structure of the tableware can be reinforced to enhance strength, water resistance, and thermal stability of the tableware.

A weight ratio of the konjac powder to the alkaline agent is 18 to 22, and preferably is 19 to 20. If the weight ratio is less than 18, the deacetylation would be reduced, so that the block mass would be easily cracked during the subsequent modulating process, and the block mass is hardly to be formed. If the weight ratio of the konjac powder to the alkaline agent is more than 22, there would have undissolved alkaline agent in the block mass, making a tableware-shaped dough formed by the block mass would be easily broken up during the subsequent modulating process. Thus, the tableware with desired shapes can not be obtained.

The preparing process described above can be performed by using well-known methods in the art, but it should be achieved the purpose of mixing uniformly the konjac powder, the alkaline agent, and the water, as well as forming the block mass.

After the operation 110, a modulating process is performed on the block mass to obtain a tableware-shaped dough, as illustrated in an operation 120. The modulating process is performed at a temperature of less than 70° C., and preferably at 18° C. to 35° C. For example, the modulating process is performed at room temperature without an additional temperature control. If the temperature of the modulating process is not less than 70° C., the excessive temperature might cause the block mass to be harder, so that the block mass cannot be subjected to the modulating process, or there are defects in a structure of the tableware-shaped dough after the modulating process. Therefore, the strength, the water resistance, and the thermal stability of the tableware are decreased.

In some embodiments, the modulating process can be performed by well-known methods in the art. In the embodiments for manufacturing the straw, the block mass is extruded to be shaped into the tubular dough though a forming mold by using a single-screw extruder or a double-screw extruder. In some specific examples, a thickness (such as thicknesses of a straw wall or a vessel wall) of the tableware-shaped dough is 0.1 mm to 5 mm. When the thickness of the sidewall of the tableware-shaped dough for the straw is in the range described above, the resulted straw can provide a user comfortable feeling and facilitate maintenance of an elasticity of the straw during used. In addition, the shape and size of the tableware-shaped dough are not specifically limited, and depend on kinds and usages of the resulted tableware. For example, a length of the tableware-shaped dough for the straw can be adjusted according to a drink, a container accommodating the drink, and a user's preference, which is not specifically limited, such as 10 cm to 30 cm. A shape of the tableware-shaped dough for the spoon, the bowl, the plate, and the cup can be adjusted according to a content accommodated by the tableware and a volume of the content. A thickness of the tableware-shaped dough for the chopsticks and the fork can be adjusted according to a hardness of the food.

After the operation 120, a deacetylation process is performed on the tableware-shaped dough to obtain an non-setting tableware, as illustrated in an operation 130. The deacetylation process is performed by using a water body to contact the tableware-shaped dough, and a temperature of the water body is not less than 65° C. Specifically, when the tableware-shaped dough contacts with the water body, the konjac powder and the alkaline agent can occur a deacetylation. If the temperature of the water body is less than 65° C., a rate of the deacetylation would be slow, and the deacetylation would be incomplete, such that the whole structure of the non-setting tableware would not be uniform, which may cause the whole structure of the tableware uniform, and further reduce the strength, the water resistance, and the thermal stability of the tableware. In some preferable examples, the temperature of the water body can be 65° C. to 100° C. to facilitate to perform the operation 130 in atmospheric pressure, therefore, it can simplify the complexity of the processes.

After the operation 130, a drying process and a water-proofing process are sequentially performed on the non-setting tableware to obtain a tableware, as illustrated in an operation 140. In some embodiments, the drying process can be performed by using hot air to dry the non-setting tableware. In some specific examples, a temperature of the drying process is more than 70° C. but not more than 100° C. When the temperature of the drying process is in the aforementioned range, it facilitates to perform the subsequent water-proofing process, so as to reduce the water content in the structure of the tableware. Therefore, the strength, the water resistance, and the thermal stability of the tableware are enhanced.

The aforementioned water-proofing process is performed by using an oil with a temperature of 100° C. to 180° C. to contact the non-setting tableware after the drying process, so as to make the non-setting tableware water-proofing. For example, the water-proofing process is performed by using the oil with a temperature described above to deeply fry the aforementioned tube body. Preferably, the temperature of the water-proofing process can be 135° C. to 145° C. If the temperature of the water-proofing process is less than 100° C., the water-proofing effect would be bad, and water would be left in the structure of the tableware, such that the strength, the water resistance, and the thermal stability of the tableware would be reduced. Furthermore, the lower temperature also could reduce a reactivity of an electrophilic addition reaction between unsaturated carbon bonds in the chemical structure of the unsaturated fatty acids contained in the oil and hydroxyl groups in a chemical structure of molecules of the konjac powder, and thus a degree of cross-linking of a cross-linked structure generated by the unsaturated carbon bonds and the hydroxyl groups would be reduced. Further, a glass transition temperature of the resulted tableware would be decreased, and the strength, the water resistance, and the thermal stability of the tableware would be reduced. If the temperature of the water-proofing process would be more than 180° C., the higher temperature would readily cause the structure of the tableware become seriously brittle. The seriously brittle tableware could not provide good tensile strength, and thus it would not have elasticity and could not provide the function for drinking a drink to a user.

For example, a processing time of the water-proofing process can be 1 minute to 5 minutes. When the processing time of the water-proofing process is in the aforementioned range, the water left in the structure of the tableware can be reduced, and thus the strength, the water resistance, and the thermal stability of the tableware are enhanced. In addition, the reactivity of the reaction between the unsaturated carbon bonds of the unsaturated fatty acids and the hydroxyl groups in the chemical structure of the molecules of the konjac powder is enhanced, and thus the degree of cross-linking of the cross-linked structure generated by the unsaturated carbon bonds and the hydroxyl groups is increased. Further, the glass transition temperature of the resulted tableware is increased, and the strength, the water resistance, and the thermal stability of the tableware are enhanced.

The oil described above includes the unsaturated fatty acids. In some embodiments, a polyunsaturation of the unsaturated fatty acids can be 55% to 65%, and a monounsaturation of the unsaturated fatty acids can be 18% to 24%. Preferably, the polyunsaturation of the unsaturated fatty acids can be 60% to 62%.

When the unsaturated fatty acids have the aforementioned properties, the unsaturated carbon bonds (such as double bonds) in the chemical structure of the unsaturated fatty acids can react with the hydroxyl groups in the chemical structure of the molecules of the konjac powder in the non-setting tableware to produce ether groups, which generates the cross-linked structure. Thus, a number of the hydrophilic hydroxyl groups of the tableware is reduced, and the hydrophilic hydroxyl groups become ether groups which is more hydrophobic, so as to provide the tableware function of the water resistance. In addition, the cross-linked structure created by the ether groups also can increase the glass transition temperature and a mechanical strength (such as the tensile strength) of the tableware, and thus the water resistance, the strength, and the thermal stability of the tableware are enhanced.

In some embodiments, because the ether groups formed from the aforementioned unsaturated fatty acids and the molecules of the konjac powder can enhance the water resistance and the thermal stability of the tableware, the water-proofing process can exclude performing a hydrophobic treatment (such as a modification by using a hydrophobic modifier to modify a surface of the tableware) on a surface of the tableware in the method 100, and the method 100 can simplify the complexity of the processes.

In addition to the konjac powder, the alkaline agent, and the water, a raw material of the tableware of the present invention can optionally include other material. For example, in some embodiments, the raw material of the tableware of the present invention can optionally include carboxymethylcellulose, methylcellulose, glycerin, vegetable chitosan, soybean pulp, rice straw, glucose or any other natural material without environmental impact, or any combinations thereof. The raw material of the tableware of the present invention can be adjusted according to properties correspondingly possessed by the resulted tableware. The carboxymethylcellulose and methylcellulose can react with the molecules of the konjac powder to generate a network macromolecule. The degree of cross-linking of the cross-linked structure of the tableware can be enhanced, and the surface of the tableware can become smooth, thereby increasing the strength of the tableware and the user's comfortability during using the tableware. Glycerin can increase a distance between long-chain molecules of glucomannan included in the konjac powder, such that the strain and the elasticity of the tableware are enhanced, thereby enhancing elastic deformation of the tableware. The vegetable chitosan can provide the tableware antibacterial activity and has a good compatibility for the konjac powder, thereby enhancing storage stability of the tableware. In addition, molecules of the vegetable chitosan can provide hydrogen bonds, so as to enhance the thermal stability of the tableware. Furthermore, the vegetable chitosan is plant material, and so it is suitable to vegan users. Fiber structures of soybean pulp, rice straw, rice hull, and rice bran can form dense cross-linked structures with the molecules of the konjac powder, so as to increase a non-polarity of the surface of the tableware, thereby enhancing the water resistance of the tableware.

The tableware of the present invention is manufactured by the method of manufacturing the tableware described above. The glass transition temperature of the tableware is 244.5° C. to 260° C. When the glass transition temperature of the tableware is in the aforementioned range, the resulted tableware has the cross-linked structure with a high degree of cross-linking, thereby having excellent thermal stability and good strength. In some embodiments, the chemical structure of the tableware includes ether groups formed from the unsaturated fatty acids. When the chemical structure of the tableware includes the aforementioned ether groups, the resulted tableware has excellent water resistance, excellent strength, and excellent thermal stability.

A weight-loss temperature, at which a weight loss of the tableware is 50% based on an original weight of the tableware, is measured by a thermogravimetric analyzer and is used to evaluate the thermal stability of the tableware. The higher temperature the tableware can bear, the better the thermal stability of the tableware has. When the aforementioned temperature is more than 244.5° C., the tableware has good thermal stability, so as to ensure the user's safety during drinking a hot drink. Preferably, the aforementioned temperature can be more than 250° C.

With comparison to the conventional plastic tableware, the tableware of the present invention is manufactured by using the biodegradable material including the konjac powder, the alkaline agent, and the water, and the tableware of the present invention does not result in environmental pollution. After used, the tableware of the present invention can be recycled, for example, as fish feed or a raw material of compost.

Moreover, with comparison to the conventional biodegradable tableware (such as paper tableware, starch-based tableware, and hydrogel-based tableware), the tableware of the present invention is manufactured by the water-proofing process using the oil including the unsaturated fatty acids. Therefore, the water in the structure of the tableware can be substantially totally removed, and the hydrophobic cross-linked structure is generated, and so that the tableware of the present invention has excellent water resistance, excellent strength, and excellent thermal stability. Furthermore, because the water can be substantially totally removed and the cross-linked structure becomes more hydrophobic, it is not necessary for the tableware of the present invention to be stored in vacuum packaging. The tableware of the present invention hardly absorbs moisture, so that microorganisms (such as mold) can hardly grow, or the tableware can hardly become deteriorated (such as decomposed) when the tableware is stored at room temperature and in normal humidity and without packaging.

The following embodiments are used to illustrate the applications of the present invention, but they are not used to limit the present invention, it could be made by various changes or modifications for a person having ordinary skill in the art without departing from the spirit and scope of the present invention.

Manufacturing of Straw

### Embodiment 1

In manufacturing of a straw of embodiment 1, food-graded konjac powder were added to water, and were stirred to mix. Then, an aqueous solution of calcium hydroxide was added into the konjac powder. After mixed, the konjac powder were stirred until a block mass was formed. Next, at room temperature, the block mass was extruded to be shaped into a tableware-shaped dough with a thickness of a sidewall of 0.5 mm to 4.2 mm by using an extruder, and the tableware-shaped dough was cut in a length of 10 cm to 25 cm. Then, the tableware-shaped dough was dipped in a water bath with a temperature of 70° C. to 80° C. After 1 minute to 5 minutes, a non-setting tableware was picked and obtained from the water bath. Next, the non-setting tableware was dried at 70° C. to 85° C., and then was deeply fried in soybean oil including unsaturated fatty acids with 62% polyunsaturation and having a temperature of 140° C. for 3 minutes, so as to manufacture the straw of embodiment 1.

### Embodiments 2 to 9 and Comparative Embodiments 1 to 5

Embodiments 2 to 9 and comparative embodiments 1 to 5 were practiced with the same method as in embodiment 1. Different from embodiment 1, different water-proofing processes were used in embodiments 2 to 9. Different from embodiment 1, different weight ratios of the konjac powder to the alkaline agent were used in comparative embodiments 1 to 2. Different from embodiment 1, different water-proofing processes were used in comparative embodiments 3 to 5. Specific conditions and evaluated results of embodiments 2 to 9 and comparative embodiments 1 to 5 described above were shown in Tables 1 to 2 below.

Evaluation Methods

1. Test of Tensile Strength

In the test of the tensile strength, the tensile strength was measured according to a standard method (American Society for Testing Materials (ASTM) D-638). When the tensile strength was more than 65 MPa, the straw had a good tensile strength.

2. Test of Water Resistance

In the test of the water resistance, the straw was totally dipped in water at a room temperature for 10 minutes, and then picked from the water. The straw was weighted before and after dipping in the water, and a variation of the weight was obtained based on the weight before dipping in the water as 100 wt %. The variation of the weight represented in weight percentage was referred to as water absorption, and it was used to evaluate water resistance. When the variation of the weight was less than 55 wt. %, the straw had good water resistance.

3. Test of Glass Transition Temperature

In the test of the glass transition temperature, the straw was grinded into fine powders, and then the fine powders were used to measure the glass transition temperature by a differential scanning calorimeter, wherein the parameters were those used by a person having ordinary skill in the art.

4. Test of Thermal Stability

In the test of the thermal stability, a temperature, at which a weight loss of the straw is 50% based on an original weight of the straw, was measured by a thermogravimetric analyzer and was used to evaluate the thermal stability of the straw, wherein the parameters were those used by a person having ordinary skill in the art. When the aforementioned temperature was more than 244.5° C., the straw had good thermal stability.

5. Test for Detecting Ether Groups

In the test for detecting the ether groups, an infrared spectrum of the straw was measured by an infrared spectrometer to determine whether ether groups were existed in the chemical structure of the straw. When there was one or more absorption peaks in a wavelength of 1010 cm⁻¹ to 1040 cm⁻¹, the chemical structure of the straw had ether groups, wherein the parameters were those used by a person having ordinary skill in the art.

TABLE 1

| | | | Embodiment | | | | |
|---|---|---|---|---|---|---|---|
| | | | 1 | 2 | 3 | 4 | 5 |
| Composition | Amount of konnyaku powders | | 5.7 | 5.7 | 5.7 | 5.7 | 5.7 |
| | (weight percent) | | | | | | |
| | Amount of calcium hydroxide | | 0.3 | 0.3 | 0.3 | 0.3 | 0.3 |
| | (weight percent) | | | | | | |
| | Amount of water | | 94 | 94 | 94 | 94 | 94 |
| | (weight percent) | | | | | | |
| Manufacturing | Deacetylation process | | Preformed | | | | |
| method | Water-proofing | Temperature of | 140 | 140 | 140 | 160 | 160 |
| | process | oil (° C.) | | | | | |
| | | Period (minute) | 3 | 1 | 5 | 1 | 3 |

| | | | | | | |
|---|---|---|---|---|---|---|
| Evaluated | Tensile strength (MPa) | 80 | 76 | 73 | 71 | 75 |
| result | Water resistance (wt. %) | 31 | 43 | 42 | 51 | 43 |
| | Glass transition temperature (° C.) | 256.4 | 255.0 | 251.2 | 247.0 | 248.7 |
| | Weight-loss temperature (° C.) | 333.0 | 331.3 | 331.0 | 329.0 | 329.5 |
| | Ether group | Yes | Yes | Yes | Yes | Yes |

| | | | Embodiment | | | |
|---|---|---|---|---|---|---|
| | | | 6 | 7 | 8 | 9 |
| Composition | Amount of konnyaku powders | | 5.7 | 5.7 | 5.7 | 5.7 |
| | (weight percent) | | | | | |
| | Amount of calcium hydroxide | | 0.3 | 0.3 | 0.3 | 0.3 |
| | (weight percent) | | | | | |
| | Amount of water | | 94 | 94 | 94 | 94 |
| | (weight percent) | | | | | |
| Manufacturing | Deacetylation process | | Preformed | | | |
| method | Water-proofing | Temperature of | 160 | 120 | 120 | 120 |
| | process | oil (° C.) | | | | |
| | | Period (minute) | 5 | 1 | 3 | 5 |

| | | | | | |
|---|---|---|---|---|---|
| Evaluated | Tensile strength (MPa) | 76 | 71 | 69 | 70 |
| result | Water resistance (wt. %) | 39 | 50 | 48 | 53 |
| | Glass transition temperature (° C.) | 245.1 | 244.7 | 245.0 | 245.0 |
| | Weight-loss temperature (° C.) | 330.0 | 318.8 | 320.0 | 318.0 |
| | Ether group | Yes | Yes | Yes | Yes |

TABLE 2

| | | | Comparative embodiment | | | | |
|---|---|---|---|---|---|---|---|
| | | | 1 | 2 | 3 | 4 | 5 |
| Composition | Amount of konnyaku powders | | 4 | 5.7 | 5.7 | 5.7 | 5.7 |
| | (weight percent) | | | | | | |
| | Amount of calcium hydroxide | | 0.4 | 0.2 | 0.3 | 0.3 | 0.3 |
| | (weight percent) | | | | | | |
| | Amount of water | | 95.6 | 94.1 | 94 | 94 | 94 |
| | (weight percent) | | | | | | |
| Manufacturing | Deacetylation process | | No preformed | | Preformed | | |
| method | Water-proofing | Temperature of oil | No preformed | | 95 | 95 | 95 |
| | process | (° C.) | | | | | |
| | | Period (minute) | | | 1 | 3 | 5 |

| | | | | | | |
|---|---|---|---|---|---|---|
| Evaluated | Tensile strength (MPa) | NA | NA | 60 | 64 | 60 |
| result | Water resistance (wt. %) | NA | NA | 67 | 56 | 69 |
| | Glass transition temperature (° C.) | NA | NA | 244.2 | 242.3 | 244.3 |
| | Weight-loss temperature (° C.) | NA | NA | 317.0 | 316.5 | 317.4 |
| | Ether group | NA | NA | Yes | Yes | Yes |

″NA″ represented that the test was not performed, and thus the evaluated result

was not obtained.
The modulating processes were performed at room temperature.
The temperature of the deacetylation process was 70° C. to 85° C.

Referring to Table 1, with comparison to comparative embodiments 1 to 2, the appropriate weight ratios of the konjac powder to the alkaline agent were used in embodiments 1 to 9, so as to obtain the tableware-shaped dough with more completely deacetylation. Thus, the straws with better strength, better water resistance, and better thermal stability were manufactured. However, in comparative embodiment 1, a lower weight ratio of the konjac powder to the alkaline agent resulted in a reduction of the deacetylation, and so that the block mass was broken up during extruded, and would not be shaped into the tableware-shaped dough. Thus, neither its subsequent processes nor its tests were performed. Besides, in comparative embodiment 2, a higher weight ratio of the konjac powder to the alkaline agent caused the alkaline agent be undissolved. The undissolved alkaline agent made the tableware-shaped dough formed by the block mass easily broken up, such that the straw with a desired length was not obtained, or the tableware-shaped dough was not formed. Thus, neither its subsequent processes nor its tests were performed.

With comparison to comparative embodiments 3 to 5, the appropriate temperature and the appropriate processing time of the water-proofing process were used in embodiments 1 to 9, so as to accomplish better water-proofing effect and to enhance the degree of cross-linking of the chemical structure of the straws. Thus, the straws with better strength, better water resistance, and better thermal stability are manufactured.

It should be understood by those of ordinary skills in the art that the aforementioned processes of manufacturing the straw can also be used to manufacture other tableware (such as chopsticks, a fork, a spoon, a bowl, a plate, and/or a cup) by changing the aforementioned mold.

In summary, in an application of the tableware and the method of manufacturing the tableware, where the tableware with good strength, excellent water resistance, and excellent thermal stability are manufactured by using the specific weight ratio of the konjac powder to the alkaline agent, the specific temperature of the modulating process, and the water-proofing process using oil.

Although the present invention has been disclosed in several embodiments as above mentioned, these embodiments do not intend to limit the present invention. Various changes and modifications can be made by those of ordinary skills in the art of the present invention, without departing from the spirit and scope of the present invention. Therefore, the claimed scope of the present invention should be defined by the appended claims.

What is claimed is:

1. A method of manufacturing a tableware, comprising:
performing a preparing process on konjac powder, an alkaline agent and a water to form a block mass, wherein a weight ratio of the konjac powder to the alkaline agent is 18 to 22;
performing a modulating process on the block mass to obtain a tableware-shaped dough, wherein the modulating process is performed at a temperature of less than 70° C.;
performing a deacetylation process on the tableware-shaped dough to obtain an non-setting tableware, wherein a water body is used to contact the tableware-shaped dough during the deacetylation process, and a temperature of the water body is not less than 65° C.; and
sequentially performing a drying process and a water-proofing process on the non-setting tableware to obtain the tableware, wherein the water-proofing process is performed by using an oil to contact the non-setting tableware after the drying process, a temperature of the oil is 100° C. to 180° C., and the oil comprises unsaturated fatty acids.

2. The method of manufacturing the tableware of claim 1, wherein an amount of the konjac powder is 3 weight percents to 10 weight percents, based on a total weight of the konjac powder, the alkaline agent, and the water as 100 weight percents.

3. The method of manufacturing the tableware of claim 1, wherein the alkaline agent is selected from a group consisting of potassium hydroxide, sodium hydroxide, magnesium oxide, calcium oxide, magnesium hydroxide, and calcium hydroxide.

4. The method of manufacturing the tableware of claim 1, wherein a thickness of a sidewall of the tableware-shaped dough is 0.1 mm to 5 mm.

5. The method of manufacturing the tableware of claim 1, wherein a temperature of the drying process is more than 70° C. but not more than 100° C.

6. The method of manufacturing the tableware of claim 1, wherein a polyunsaturation of the unsaturated fatty acids is 55% to 65%.

7. The method of manufacturing the tableware of claim 1, wherein a processing time of the water-proofing process is 1 minute to 5 minutes.

8. The method of manufacturing the tableware of claim 1, wherein the water-proofing process excludes performing a hydrophobic treatment on a surface of the tableware.

9. The method of manufacturing the tableware of claim 1, wherein carboxymethylcellulose, methylcellulose, glycerin, vegetable chitosan, soybean pulp, rice straw and/or glucose is further used in the preparing process.

10. The method of manufacturing the tableware of claim 1, wherein the tableware is selected from a group consisting of chopsticks, a fork, a spoon, a bowl, a plate, a cup, and a straw.

11. A tableware produced by the method for manufacturing the tableware of claim 1, wherein a glass transition temperature of the tableware is 244.5° C. to 260° C.

12. The tableware of claim 1, wherein a chemical structure of the tableware comprises hydrophobic groups formed from the unsaturated fatty acids.

13. A method of manufacturing a tableware, comprising:
performing a preparing process on konjac powder, an alkaline agent and a water to form a block mass, wherein a weight ratio of the konjac powder to the alkaline agent is 18 to 22;
performing a modulating process on the block mass to obtain a tableware-shaped dough, wherein the modulating process is performed at a temperature of less than 70° C.;
performing a deacetylation process on the tableware-shaped dough to obtain an non-setting tableware, wherein a water body is used to contact the tableware-shaped dough during the deacetylation process, and a temperature of the water body is 65° C. to 100° C.; and
sequentially performing a drying process and a water-proofing process on the non-setting tableware to obtain the tableware, wherein the water-proofing process is performed by using an oil to contact the non-setting tableware after the drying process, a temperature of the oil is 100° C. to 180° C., the oil comprises unsaturated fatty acids, and a polyunsaturation of the unsaturated fatty acids is 55% to 65%.

14. The method of manufacturing the tableware of claim 13, wherein an amount of the konjac powder is 3 weight percents to 10 weight percents, based on a total weight of the konjac powder, the alkaline agent, and the water as 100 weight percents.

15. The method of manufacturing the tableware of claim 13, wherein the alkaline agent is selected from a group consisting of potassium hydroxide, sodium hydroxide, magnesium oxide, calcium oxide, magnesium hydroxide, and calcium hydroxide.

16. The method of manufacturing the tableware of claim 13, wherein a thickness of a sidewall of the tableware-shaped dough is 0.1 mm to 5 mm.

17. The method of manufacturing the tableware of claim 13, wherein a temperature of the drying process is more than 70° C. but not more than 100° C.

18. The method of manufacturing the tableware of claim 13, wherein a monounsaturation of the unsaturated fatty acids is 18% to 24%.

19. The method of manufacturing the tableware of claim 13, wherein the water-proofing process excludes performing a hydrophobic treatment on a surface of the tableware.

20. The method of manufacturing the tableware claim 13, wherein the tableware is selected from a group consisting of chopsticks, a fork, a spoon, a bowl, a plate, a cup, and a straw.
